(19) United States
(12) Patent Application Publication
(10) Pub. No.: US 2007/0134039 A1
(43) Pub. Date: Jun. 14, 2007

(54) Dual-sided thermal printing

(75) Inventors: Michael J. Van Demark, Springboro, OH (US); Dale R. Lyons, Suwanee, GA (US); Justin L. Collins, Woodstock, GA (US); Michael Lee Barlow, Duluth, GA (US); Sachio Koyama, Singapore (SG); Yasutoshi Serizawa, Singapore (SG)

Correspondence Address: Douglas S. Foote;Intellectual Property Section, Law Department, NCR Corporation, 1700 South Patterson Blvd., Dayton, OH, 45479-0001, US

(73) Assignee: NCR Corporation

(21) Appl. No.: 11/297,706

(22) Filed: Dec. 8, 2005

(51) Int. Cl. B41J 3/60; B41J 29/38

(52) U.S. Cl. 400/61

(57) ABSTRACT

A dual-sided imaging direct thermal printer includes a switch enabling activation and deactivation of a dual-sided printing function. The printer is configured to allow printing on both sides of a receipt or other sheet media moving along a feed path through the printer and comprises a print head on each side of the media feed path. An opposing platen is disposed on each side of the feed path across from an associated print head. A described switch enables dual-sided printer benefits with simplex-mode software.

### BACKGROUND

Duplex or dual-sided direct thermal printing of transaction documents or receipts is described in U.S. Pat. Nos. 6,784,906 and 6,759,366. The printers are configured to allow printing on both sides of thermal media moving along a feed path through the printer. In such printers a direct thermal print head is disposed on each side of the media feed path. A thermal print head faces an opposing platen across the feed path from the print head.

In direct thermal printing, a print head selectively applies heat to paper or other sheet media comprising a substrate with a thermally sensitive coating. The coating changes color when heat is applied, by which “printing” is provided on the coated substrate. For dual-sided direct thermal printing, the sheet media substrate may be coated on both sides.

Duplex or dual-sided direct thermal printing has been described for providing variable information on both sides of a paper receipt, to save materials and to provide flexibility in providing information to customers. The printing could be driven electronically or by computer using a computer application program which directs dual-sided printing. However, it would be desirable to also be able to use a dual-sided direct thermal printer in conjunction with simplex mode programs for printing of receipts or other documents. This would allow use of dual-sided thermal printers without having to replace or forgo use of existing applications or other programs with only a simplex mode of printer functioning.

### SUMMARY

A dual-sided imaging direct thermal printer includes a switch, e.g., implemented in hardware or software or a combination of the two, enabling activation and deactivation of a dual-sided printing function. The printer is configured to allow printing on both sides of a paper receipt, document, label or other thermal media moving along a feed path through the printer and comprises a print head on each side of the media feed path. An opposing platen is disposed on each side of the feed path across from an associated print head. A described switch enables dual-sided printer benefits with legacy simplex-mode software.

### BRIEF DESCRIPTION OF DRAWINGS

FIG. 1 shows a schematic of a dual-sided imaging direct thermal printer useable for dual-sided, single pass printing of thermal media such as transaction receipts or tickets.

FIG. 2A shows a receipt with transaction detail printed on the front side.

FIG. 2B shows a receipt with supplemental information printed on the reverse side, such as variable stored information determined at the time of the transaction.

FIG. 3A shows a two-sided receipt with a portion of the associated transaction detail printed on the front side of the receipt.

FIG. 3B shows the reverse side of the receipt shown in FIG. 3A on which the remaining portion of the associated transaction data is printed.

### DETAILED DESCRIPTION

By way of example, various embodiments of the invention are described in the material to follow with reference to the included drawings. Variations may be adopted.

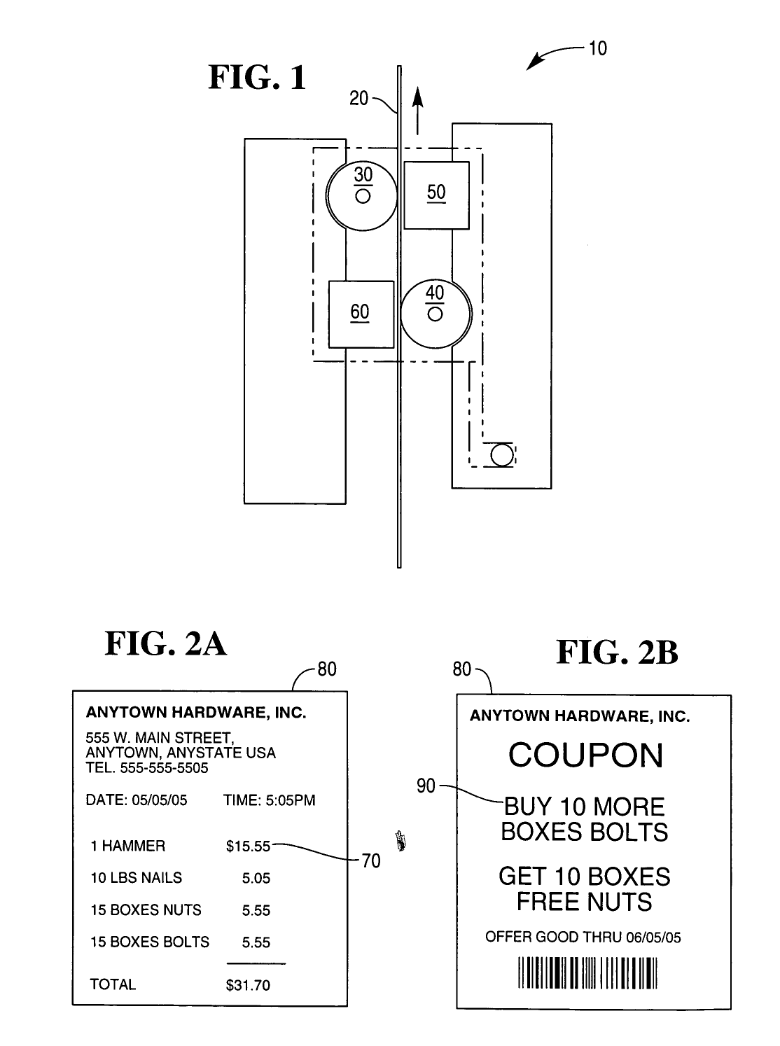

FIG. 1 shows a schematic of a dual-sided imaging direct thermal printer 10 useable for dual-sided, single pass printing of transaction receipts or tickets at time of issue. The printer 10 operates on print media 20 which is double-sided thermal paper, e.g., comprising a cellulosic or polymer substrate sheet coated on each side with heat sensitive dyes as described in U.S. Pat. Nos. 6,784,906 and 6,759,366. Multi-color printing capability can be provided on both sides of the receipt by using two or more dyes on a side where multi-color printing is desired. Substrates and heat sensitive color changing coatings for direct thermal printing media are generally well known in the art. Dual-sided direct thermal printing can be facilitated by a media 20 which includes dyes on opposite sides of the media 20, and a sufficiently thermally resistant substrate that inhibits thermal printing on one side of the media 20 from affecting coloration on the opposite side of the media 20.

The thermal print media 20 may be supplied in the form of a paper roll or sheet, e.g., to provide a voucher, coupon, receipt, ticket or other article or document, upon which printing such as graphics or text, or both, may be printed on both sides of the media 20.

As shown in FIG. 1, the printer 10 has rotating platens 30 and 40 and opposing thermal print heads 50 and 60 on opposite sides of the printed thermal media 20. Dual-sided direct thermal printing of the media 20 occurs in a single pass at the time of the transaction or when a receipt or ticket is issued. The media 20 can be cut or severed to provide an individual receipt or ticket document, typically once printing is completed.

FIG. 2A shows transaction detail 70 such as issuer identification, time, date, line item entries and a transaction total printed on the front side of a receipt 80. FIG. 2B shows custom information 90, e.g., based on recipient identity or transaction detail ascertained at transaction time, printed on the reverse side of the receipt 80. For example, custom information 90 could include further or duplicate transaction information, a coupon as shown, rebate or contest information, serialized cartoons, conditions of sale, document images, advertisements, security features, ticket information, or other information, e.g., custom information based on recipient identity or transaction data or detail.

Dual-sided imaging direct thermal printer 10 includes a switch enabling activation and deactivation of one or more dual-sided printing functions. The dual-sided printer 10 is configured to allow printing on both sides of a receipt or other sheet media 20 moving along a feed path 25 through the printer 10 with print heads 50 and 60 on opposite sides of the media feed path 25. Print heads 50 and 60 have associated opposing platens 30 and 40.

The dual-sided printing function switch can be a mechanically operated switch on the printer 10, or an electronically operated switch operated by a printer driver on an associated host computer or by firmware or software resident on the printer 10. The switch may, for example, be electronically operated in response to a command message or escape sequence transmitted to the printer 10. Printer control language or job language (“PCL/PJL”) commands may be used. A printer setup configuration setting, e.g., configured by a software controlled utility page implemented on an associated host computer, could also electronically operate the function switch for the dual-sided or duplex printer 10.

Functionally, the dual-sided printing function switch can be configured to determine the side of the printing sheet media 20 on which data is to be printed, or the direction in which data is to be printed on the printing sheet media 20, or whether the printer 10 operates in a simplex, one-sided printing mode, or in a duplex, dual-sided printing mode. For example, a setting of the dual-sided printing function switch may marshal a portion, e.g., half, of a block of data to be printed on one side of the media 20 and another portion, e.g., half, to be printed on the reverse side of the media 20, or a further setting may reverse the media sides on which the respective portions of data are printed. In this manner a transaction receipt may be generated in which a portion of the associated transaction data is printed on one side of the receipt and the remaining portion of the transaction data is printed on the other side of the receipt, conserving upon the amount of media 20 required for printing of the receipt. A dual-sided printing function switch may accordingly be configured, e.g., by a control command message transmitted to the printer 10, to determine the portion or quantity of data, or a block of data, to be printed on a side of the media. Different blocks of data may be alternatively selected by the switch.

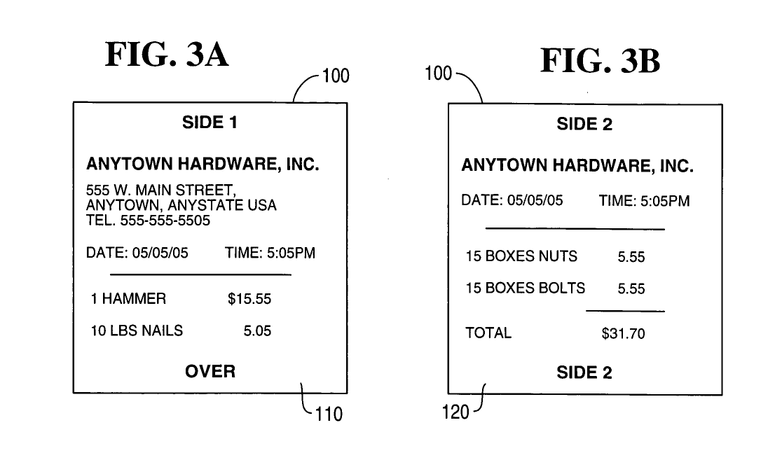

FIG. 3A shows a two-sided receipt 100 with a portion of the associated transaction detail printed on the front side 110 of the receipt 100. FIG. 3B shows the reverse side 120 of the receipt 100 shown in FIG. 3A, where the remaining portion of the associated transaction data is shown printed on the reverse side 120 of the receipt 100. Indicia such as “Front Side,” Reverse Side,“Side 1,” “Side 2,” or the like may be included on the two sides of the receipt 100 as shown to denote the two-sided nature of the receipt 100 or the respective side of the receipt 100 being viewed. Identifying indicia such as a receipt or transaction number, terminal number, store identifier, date, time or the like may be printed on both sides of the receipt to enable association of copied images of the two sides.

A dual-sided imaging direct thermal printer 10 having pre-print data storage facilities may store one or more blocks of data to be repetitively printed on a side of the media 20, e.g., with data submitted by application software to be printed on the other media side. Where multiple data blocks are stored in the printer storage, the blocks may be alternatively selected through the switch for printing, as may be the printing location.

A dual-sided imaging direct thermal printer 10 as described may be operated with a legacy application program or other application program software enabling simplex mode or other one-sided thermal media printing. A dual-sided printing function switch is used to enable duplex mode or other dual-sided thermal media printing when of such simplex mode or single-sided application program software. The switch enables activation and deactivation of one or more dual-sided printing functions in response to a manual setting, or to a command message or escape sequence transmitted to the printer 10, or a configuration setting though a driver or utility interface as previously described, while the simplex mode application software conventionally controls printing of submitted data on one media side. This functioning would allow realization of dual-sided direct thermal printer benefits with legacy software, before or without having to invest in custom duplex mode applications or other new application program software.

A simplex mode or one-sided printing application program may thus control direct thermal printing on one side of a media sheet 20, where the dual-sided printing function switch is configured to control thermal printing on the other media side. The data printed under control of the function switch may be a block of data stored at the printer 10 for repetitive printing as previously described. For example, the block of data to be printed may be selected by a command message or an escape message as previously described.

By enabling control of printing on one side of media sheet 20 by a one-sided printing application program, and enabling control of printing on the opposite side of the sheet by operation of the function switch activating and deactivating of a dual-sided direct thermal printing function, requirements for application program software may thus be simplified. Application program software for simplex mode or other one-sided printing which does not operate the dual-sided direct thermal printing function may be used, enabling stored data to be printed on one side of sheet media 20 independently of printing on the opposite side of the sheet media 20 under control of the one-sided printing application program. The function switch may thus be operated to enable dual-sided printing on the sheet media 20 under control of available existing legacy programs or other one-sided printing application program software.

The description above presents a number of specific embodiments or examples of, a broader invention. The invention is also carried out in a wide variety of other alternative ways which have not been described here. Many other embodiments or variations of the invention may also be carried out within the scope of the following claims.

What is claimed is:

1. A dual-sided imaging direct thermal printer configured to allow printing on both sides of thermal media moving along a feed path through the printer, comprising a print head on each side of said feed path, and an opposing platen on each side of said feed path, and a switch enabling activation and deactivation of a dual-sided printing function.

2. The thermal printer of claim 1 in which said switch is operated by a control command message transmitted to said printer to activate or deactivate said function.

3. The thermal printer of claim 2 in which said control command message is in the form of an escape sequence transmitted to said printer along with data to be printed.

4. The thermal printer of claim 1 in which said switch is operated by a software controlled printer setup configuration setting.

5. The thermal printer of claim 1 in which said switch is a mechanical, manually operated hardware device.

6. The thermal printer of claim 1 in which said printer is provided with data to be printed by a one-sided printing application program which does not operate said switch.

7. The thermal printer of claim 6 in which said switch is operated to enable dual-sided printing on said thermal media under control of said one-sided printing application program.

8. The thermal printer of claim 1 in which said switch determines the side of said thermal media on which data is to be printed.

9. The thermal printer of claim 1 in which said switch determines whether said printer operates in a simplex, one-sided printing mode, or in a duplex, dual-sided printing mode.

10. The thermal printer of claim 1 in which said switch determines the direction in which data is to be printed on said thermal media.

11. The thermal printer of claim 9 in which under one setting of said switch half of a block of data to be printed is printed on one side of said thermal media and the other half of said data is printed on the opposite side of said thermal media.

12. The thermal printer of claim 10 in which under another setting of said switch the sides of the thermal media on which data is printed are reversed.

13. The thermal printer of claim 1 in which a control command message transmitted to said printer determines the quantity of data to be printed on a side of said thermal media.

14. The thermal printer of claim 1 in which a control command message selects a block of data to be printed on one side of said thermal media.

15. The thermal printer of claim 1 in which said printer includes storage for storing a block of data to be repetitively printed one a side of said thermal media.

16. The thermal printer of claim 14 in which printing on the other side of said thermal media is controlled by a one-sided printing application program.

17. The thermal printer of claim 15 in which printing of said block of data on said one side of said thermal media is controlled by said switch.

18. The thermal printer of claim 1 in which said printer includes storage for storing multiple alternatively selectable blocks of data for printing on a side of said thermal media.

19. The thermal printer of claim 1 in which a block of data is selected for printing by a control command message transmitted to said printer.

20. A transaction receipt on which associated transaction data is printed, where a portion of said transaction data is printed on one side of the receipt and the remaining portion of said transaction data is printed on the reverse side of the receipt.

21. The transaction receipt of claim 20 comprising printed indicia on one side of the receipt identifying the particular side of the receipt on which said indicia is printed.

22. The transaction receipt of claim 20 comprising printed indicia on one side of the receipt indicating that there is printing on both sides of the receipt.

23. The transaction receipt of claim 20 comprising printed indicia on one side of the receipt directing attention to the other side of the receipt on which there is printing.

24. The transaction receipt of claim 20 comprising printed identifying indicia on both sides of the receipt, such as a receipt or transaction number, terminal number, store identifier, date, time or the like, to enable association of copied images of the two sides.

25. A method of dual-sided imaging using a direct thermal printer, comprising enabling control of printing on one side of media sheet by a one-sided printing application program, and enabling control of printing on the opposite side of said media sheet by operation of a switch activating and deactivating of a dual-sided printing function.

26. The method of claim 25 in which said printer includes memory enabling storage of data to be printed on one side of said sheet independently of printing on the opposite side of said sheet under control of said one-sided printing application program.
